(19) United States
(12) Patent Application Publication
(10) Pub. No.: US 2014/0126112 A1
(43) Pub. Date: May 8, 2014

(54) CARBON NANOTUBES ATTACHED TO METAL FOIL

(71) Applicant: Ultora, Inc., (US)

(72) Inventors: CATTIEN V. NGUYEN, San Jose, CA (US); Darrell L. Niemann, Santa Clara, CA (US); You Li, Sunnyvale, CA (US)

(73) Assignee: Ultora, Inc., Sunnyvale, CA (US)

(21) Appl. No.: 13/670,132

(22) Filed: Nov. 6, 2012

(51) Int. Cl. H01G 11/36

(52) U.S. Cl. CPC H01G 11/36
USPC 361/502

(57) ABSTRACT

Provided herein are novel electrodes for use, such as, for example, in electrochemical energy storage systems (i.e., Li-ion secondary batteries), fuel cells, secondary batteries based on hydrogen storage and ultracapacitors. The electrodes include carbon nanotubes attached to metal foil. In some embodiments, an ultracapacitor device is provided. The ultracapacitor device contains, inter alia, the novel electrodes described herein. In still other embodiments, a method of synthesizing the electrodes described herein is provided. Carbon nanotubes are deposited on a metal foil and amorphous carbon is removed.

### FIELD

Provided herein are novel electrodes for use, such as, for example, in electrochemical energy storage systems (i.e., Li-ion secondary batteries), fuel cells, secondary batteries based on hydrogen storage and ultracapacitors. The electrodes include carbon nanotubes attached to metal foil. In some embodiments, an ultracapacitor device is provided. The ultracapacitor device contains, inter alia, the novel electrodes described herein. In still other embodiments, a method of synthesizing the electrodes described herein is provided. Carbon nanotubes are deposited on a metal foil and amorphous carbon is removed.

### BACKGROUND

Energy storage devices, such as ultracapacitors (i.e., electrochemical capacitors, electrical double layer capacitors or supercapacitors) are increasingly important in powering a wide variety of devices such as, for example, motor vehicles, cellular telephones, computers, etc. and furthermore, may be used as a replacement for or in conjunction with conventional batteries. Ultracapacitors have a number of advantages compared to conventional batteries such as, for example, long life cycle, easy construction, short changing time, safety and high power density.

Conventional ultracapacitors include metal foils (e.g., aluminum) on which are deposited active materials which have high surface area as the electrodes. Activated carbon is the most commonly used active material, which is typically deposited on metal foils as a paste and forms a thin film on the surface of the foil.

Recently, carbon nanotubes have been used as active materials in electrodes to form ultracapacitors. Similarly to activated carbon, carbon nanotubes can be deposited as a paste, which includes a binder, on metal foils. However, deposition of carbon nanotubes as a paste leads to increased high interface resistance because of the continuing presence of the binder, which leads to poor power performance of the capacitor. Alternatively, carbon nanotubes may be grown on metal foils with co-deposition of a metal catalyst. However, the continuing presence of the catalyst leads to poor power performance of the capacitor.

More recently, chemical vapor deposition has been used to directly grow continuous films of both vertically aligned or randomly dispersed carbon nanotubes on thick, highly polished metal substrates. Such carbon nanotubes are useful electrodes for constructing an ultracapacitor but are costly and are difficult to package and/or mold.

Accordingly, what is needed are electrodes that include carbon nanotubes dispersed on thin metal foil, methods for making such electrodes and ultracapacitors made using such electrodes.

### SUMMARY

The present invention satisfies these and other needs by providing electrodes which contain carbon nanotubes dispersed on thin metal foil, methods for making such electrodes and ultracapacitors made using such electrodes.

In one aspect, an electrode including carbon nanotubes is provided. The carbon nanotubes are attached to a metal foil. In some embodiments, the metal foil has a thickness of less than about than 500 μm. In other embodiments, the metal foil has a root mean square roughness of less than about 200 nm. In still other embodiments, the metal foil has a thickness of less than about than 500 μm and a root mean square roughness of less than about 200 nm.

In another aspect, a method of synthesizing an electrode which includes carbon nanotubes is provided. In some embodiments, carbon nanotubes are deposited on a metal foil by chemical vapor deposition and amorphous carbon is removed. In other embodiments, amorphous carbon is removed simultaneously during chemical vapor deposition. In still other embodiments, amorphous carbon is removed simultaneously during chemical vapor deposition and also in a discrete second step. In some embodiments, the metal foil has a thickness of less than about than 500 μm. In other embodiments, the metal foil has a root mean square roughness of less than about 200 nm. In still other embodiments, the metal foil has a thickness of less than about than 500 μm and a root mean square roughness of less than about 200 nm.

In still another aspect, a method of synthesizing an electrode which includes carbon nanotubes in a roll to roll manufacturing process is provided. In some embodiments, carbon nanotubes are deposited on a roll of metal foil by chemical vapor deposition and amorphous carbon is removed. In other embodiments, amorphous carbon is removed simultaneously during chemical vapor deposition. In still other embodiments, amorphous carbon is removed simultaneously during chemical vapor deposition and also in a discrete second step. In some embodiments, the roll of metal foil has a thickness of less than about than 500 μm. In other embodiments, the roll of metal foil has a root mean square roughness of less than about 200 nm. In still other embodiments, the roll of metal foil has a thickness of less than about than 500 μm and a root mean square roughness of less than about 200 nm.

In still other embodiments, an ultracapacitor device is provided. The ultracapacitor has at least one electrode which includes carbon nanotubes attached to a metal foil. In some embodiments, the metal foil has a thickness of less than about than 500 μm. In other embodiments, the metal foil has a root mean square roughness of less than about 200 nm. In still other embodiments, the metal foil has a thickness of less than about than 500 μm and a root mean square roughness of less than about 200 nm.

### BRIEF DESCRIPTION OF THE SEVERAL VIEWS OF THE DRAWINGS

FIG. 1 illustrates a metal foil with dimensions;

FIG. 2A illustrates carbon nanotubes grown directly on one side of a metal foil to provide a one-sided CNT;

FIG. 2B illustrates carbon nanotubes grown directly on two sides of a metal foil to provide a two-sided CNT;

FIG. 3 illustrates roll-to-roll processing for growing carbon nanotubes on metal foils;

FIG. 4A illustrates carbon nanotubes attached to a metal foil in the presence of amorphous carbon impurities;

FIG. 4B illustrates carbon nanotubes attached to a metal foil after amorphous carbon impurities have been removed;

FIG. 5A illustrates electrodes, which include carbon nanotubes attached to a metal foil separated by a membrane;

FIG. 5B illustrates electrodes, which include carbon nanotubes attached to a metal foil coupled to a membrane;

FIG. 5C illustrates electrodes, which include carbon nanotubes attached to a metal foil coupled to a membrane immersed in an electrolyte;

FIG. 6 illustrates an example of a device composed of a 2-sided CNT electrode; and

FIG. 7 illustrates coupling of the carbon nanotubes to the membrane and submersion of the carbon nanotubes in electrolyte solution.

### DETAILED DESCRIPTION

### Definitions

Unless defined otherwise, all technical and scientific terms used herein have the same meaning as is commonly understood by one of ordinary skill in the art to which this invention belongs. In the event that there is a plurality of definitions for a term herein, those in this section prevail unless stated otherwise.

As used herein “carbon nanotubes” refer to allotropes of carbon with a cylindrical structure. Carbon nanotubes may have defects such as inclusion of C5 and/or C7 ring structures such that the carbon nanotube is not straight and may have periodic coiled structures.

As used herein “ultracapacitors” include electrochemical capacitors, electrical double layer capacitors and supercapacitors.

As used herein “chemical vapor deposition” refers to plasma enhanced chemical vapor deposition or thermal chemical vapor deposition.

As used herein “plasma enhanced chemical vapor deposition” refers to the use of plasma (e.g., glow discharge) to transform a hydrocarbon gas mixture into excited species which deposit carbon nanotubes on a metal foil.

As used herein “thermal chemical vapor deposition” refers to the thermal decomposition of hydrocarbon vapor in the presence of a catalyst which may be used to deposit carbon nanotubes on a metal foil.

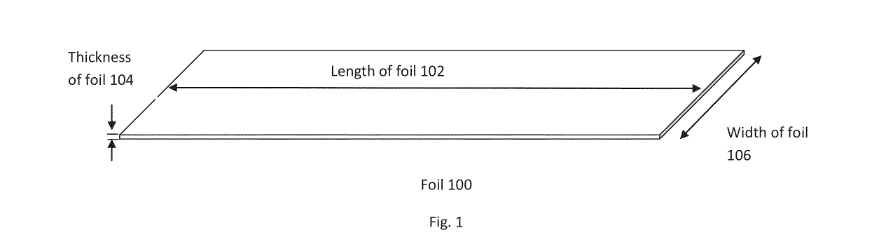

Referring now to FIG. 1, a metal foil 100 is selected. The metal foil has length 102, a thickness 104 and a width 106. In some embodiments, the metal foil may be coated with a catalyst. In other embodiments, the metal foil may be coated with a material that prevents attachment of carbon nanotubes to the metal foil (i.e, a protective coating). In still other embodiments, the protective coating may partially cover either side of the metal foil. In still other embodiments, the protective coating completely covers one side of the metal foil and partially covers the other side of the metal foil. In still other embodiments, the protective coating partially covers one side of the metal foil. In still other embodiments, the protective coating completely covers one side of the metal foil. In still other embodiments, neither side of the metal foil is covered by a protective coating.

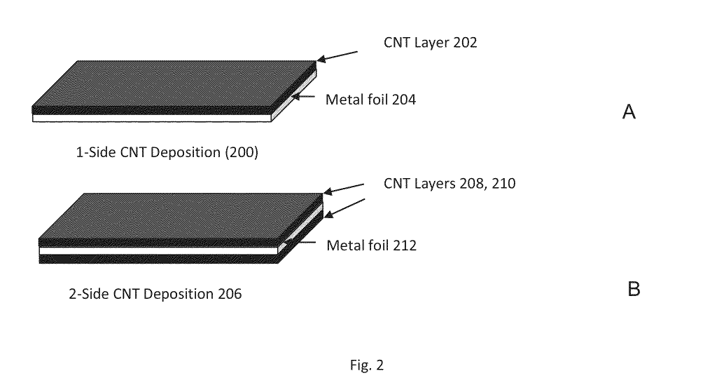

Referring now to FIG. 2A, a metal foil 204 is covered on one side with a carbon nanotube layer 202 to provide a 1 side carbon nanotube deposition 200.

Referring now to FIG. 2B, a metal foil 212 is covered on two sides with carbon nanotube layers 208 and 210 to provide a 2 side carbon nanotube deposition 206.

In some embodiments, the metal foil typically has a surface smoothness where the root mean square roughness is less than about 500 nm. In other embodiments, the root mean square roughness of the metal foil is less than about 200 nm. In still other embodiments, root mean square roughness of the metal foil is between about 2 nm and about 200 nm. In still other embodiments, the roughness of each side of the metal foil is identical. In still other embodiments, the roughness of each side of the metal foil is different. In some embodiments, it may be desirable to have different densities of carbon nanotube coatings on the two sides of the foils.

In some embodiments, the metal foil is less than 500 μm thick. In other embodiments, the metal foil is between about 500 μm and about 10 μm thick. In still other embodiments, the metal foil is between about 400 μm and about 10 μm thick. In still other embodiments, the metal foil is between about 300 μm and about 10 μm thick. In still other embodiments, the metal foil is between about 200 μm and about 10 μm thick. In still other embodiments, the metal foil is between about 100 μm and about 10 μm thick. In still other embodiments, the metal foil is between about 50 μm and about 10 μm thick.

In some embodiments, the metal foil is between about 500 μm and about 1 μm thick. In other embodiments, the metal foil is between about 400 μm and about 1 μm thick. In still other embodiments, the metal foil is between about 300 μm and about 1 μm thick. In still other embodiments, the metal foil is between about 200 μm and about 1 μm thick. In still other embodiments, the metal foil is between about 100 μm and about 1 μm thick. In still other embodiments, the metal foil is between about 50 μm and about 1 μm thick.

In some embodiments, the metal foil has a thickness of less than about than 500 μm. In other embodiments, the metal foil has a root mean square roughness of less than about 200 nm. In still other embodiments, the metal foil has a thickness of less than about than 500 μm and a root mean square roughness of less than about 200 nm

In some embodiments, the metal foil includes any elements and combinations thereof that catalyze the growth of carbon nanotubes. In other embodiments, the metal foil includes iron, nickel, aluminum, cobalt, copper, chromium, gold and combinations thereof.

In some embodiment, the metal foil comprises alloys of two or more of iron, nickel, cobalt, copper, chromium, aluminum, gold and combinations thereof. In other embodiments, the alloy is a complete solid solution alloy. In still other embodiments, the alloy is a partial solid solution alloy. In still other embodiments, the alloy is a substitutional alloy. In still other embodiments, the alloy is an interstitial alloy.

Generally, the metal foil can have any convenient or useful width, length or geometric shape. In some embodiments, the metal foil has a width greater than 1 mm Generally, the width of the metal foil may be any convenient width useful in a continuous roll-to-roll manufacturing process. In some embodiments, the metal foil has a length greater than 1 mm In other embodiments, the metal foil has a length greater than 1 m. In still other embodiments, the metal foil has a length greater than 10 m. In still other embodiments, the metal foil has a length greater than 100 m. In still other embodiments, the metal foil has a length greater than 1000 m.

In some embodiments, chemical vapor deposition is used to attach carbon nanotubes to a metal foil in a continuous roll-to-roll manufacturing process. The only requirement for the above is that the length of the metal foil is sufficient for use in a roll-to roll manufacturing process. Generally, the width and length of the metal foil may be any convenient dimension for use in a continuous roll-to-roll manufacturing process. In some embodiments, the length of the metal foil is greater than 1 meter. In other embodiments, the length of the metal foil is greater than 10 meters. In still other embodiments, the length of the metal foil is greater than 100 meters. In still other embodiments, the metal foil has a length greater than 1000 meters.

In some embodiments, chemical vapor deposition is used to attach carbon nanotubes to a metal foil in a batch manufacturing process, where one or more metal foil substrates are processed simultaneously. The metal foil may be precut into any geometric form such as a circle, square, rectangle, triangle, pentagon hexagon, etc or any other form that may be useful.

In some embodiments, chemical vapor deposition is used to attach carbon nanotubes to a metal foil in a continuous in-line manufacturing process, where one or more metal foil substrates are processed sequentially through a processing system with substrates moving linearly or radially through one or more linked processing environments. The metal foil may be precut into any geometric form such as a circle, square, rectangle, triangle, pentagon hexagon, etc or any other form that may be useful.

In some embodiments, chemical vapor deposition is used to attach carbon nanotubes to a metal foil in a cluster-tool manufacturing process, where a substrate carrier comprising one or more metal foil substrates is processed sequentially in one or more linked processing systems in which a discrete processing step is carried out sequentially on the substrate carrier. The metal foil may be precut into any geometric form such as a circle, square, rectangle, triangle, pentagon hexagon, etc or any other form that may be useful.

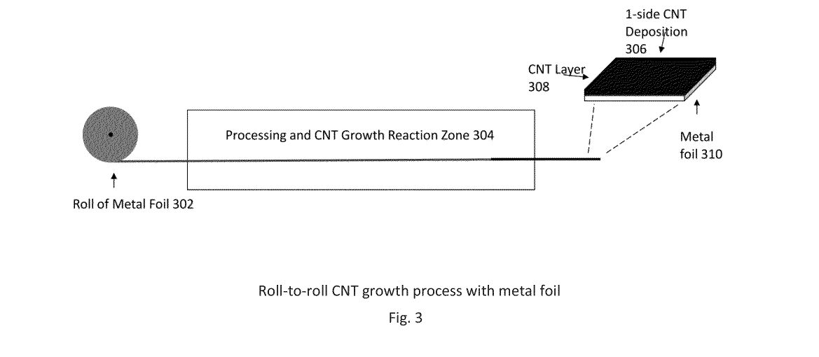

An exemplary illustration of roll-to-roll carbon nanotube growth process is illustrated in FIG. 3. A roll of metal 302 is passed through a processing and carbon nanotube growth reaction zone 304. The resultant product is metal foil 310 covered on one side with carbon nanotube layer 308 to provide, in this illustration, a 1 side carbon nanotube deposition 306.

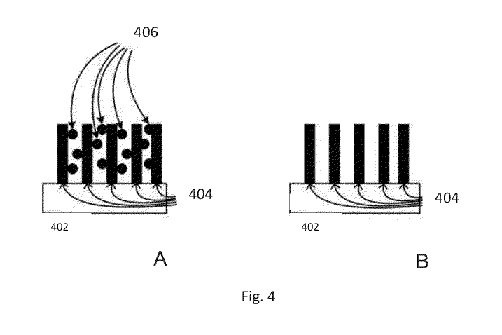

Referring now to FIG. 4A, carbon nanotubes 404 are attached to metal 402 to form an electrode. The carbon nanotubes are highly porous, have a large surface area and high percentage of usable nanopores (i.e., mesopores between about 2 nm to about 50 nm in diameter). Carbon nanotubes are chemically inert and electrically conductive. Carbon nanotubes may be single walled or multi-walled or combinations thereof. Carbon nanotubes useful in the electrodes described herein include other forms such as toruses, nanobuds and graphenated carbon nanotubes. In some embodiments, the carbon nanotubes are vertically aligned. In other embodiments, the carbon nanotubes are in a vertical tower structure (e.g., perpendicular to the metal foil). Other carbon nanotube configurations include, for example, horizontal or random alignment. In some embodiments, the carbon nanotubes are a random network with a minimal degree of alignment in the vertical direction.

In some embodiments, carbon nanotubes 404 are attached to metal foil 402 by chemical vapor deposition process. In other embodiments, carbon nanotubes are attached to metal foil by thermal chemical vapor deposition. In still other embodiments, carbon nanotubes are attached to metal foil by plasma chemical vapor deposition.

Thermal chemical vapor deposition of carbon nanotubes is usually performed with hydrocarbon sources (e.g., methane, ethylene, acetylene, camphor, naphthalene, ferrocene, benzene, xylene, ethanol, methanol, cyclohexane, fullerene, etc.), carbon monoxide, or carbon dioxide at temperatures between about 600° C. and 1200° C. preferably, in the absence of oxygen or reduced amounts of oxygen. In some embodiments, carbon nanotubes are grown directly on the metal foil without deposition of either metal catalyst or use of binders.

Plasma enhanced chemical vapor deposition of carbon nanotubes is also usually performed with hydrocarbon sources, supra. Here, electrical energy rather than thermal energy is used to activate the hydrocarbon to form carbon nanotubes on metal foils at preferred temperatures between about 300° C. and greater than 600° C. In some embodiments, carbon nanotubes are grown directly on the metal foil without deposition of either metal catalyst or use of binders.

In other embodiments, a portion of the metal foil is pretreated to prevent attachment of carbon nanotubes to that portion of the foil. In other embodiments, a portion of the metal foil is pretreated with a film such as a metal film or an organic (polymer) film that prevents the direct growth of carbon nanotubes in these areas. Films such as those described above can be deposited, for example, by metal evaporation methods (such as thermal or e-beam evaporation) or by ink jet printing to give a desired pattern. Protective films may also be patterned by using a hard mask and/or photolithography techniques. In some embodiments, carbon nanotubes are attached to one side of the metal foil. In other embodiments, carbon nanotubes are attached to both sides of the metal foil.

In some embodiments, plasma treatment (e.g., F₂, NH₃) of carbon nanotubes surfaces is used to increase surface wettability by increasing the hydrophilicity of the surface. Such treatment enables ions from electrolytes to access the pores of the carbon nanotubes which increase charge density.

Referring again to FIG. 4A, during attachment of carbon nanotubes 404 to metal foil 402, a side product is amorphous carbon 406. Amorphous carbon reduces the porosity of carbon nanotubes, thus decreasing electrode performance. In some embodiments, selection of hydrocarbon precursors and control of temperature reduces the amount of amorphous carbon formed. Amorphous carbon may be removed by a number of methods including, for example, thermal or plasma cleaning with O₂ and exposure to strong acid, halogens and strong oxidants (e.g., H₂O₂). In some embodiments, vapor which includes water or H₂O₂ or combination thereof may be used to remove amorphous carbon as described by Deziel et al., U.S. Pat. No. 6,972,056. Removal of amorphous carbon provides carbon nanotubes 404, attached to metal foil 402 shown in FIG. 4B.

In some embodiments, a continuous water treatment process is used to remove impurities such as amorphous carbon from carbon nanotubes. The process includes a wet inert carrier gas stream (e.g., argon or nitrogen) and may include an additional dry carrier gas stream which is added to adjust water concentration. Water is added using any water infusion method (e.g., bubbler, membrane transfer system, etc.). In some embodiments, water vapor is introduced into a process chamber maintained at between 600° C. and 1200° C. to remove amorphous carbon and other impurities associated with carbon nanotubes attached to a metal foil.

In some embodiments, amorphous carbon is removed in a discrete step after deposition of carbon nanotubes on the metal foil. In other embodiments, amorphous carbon is removed simultaneously during chemical vapor deposition. In still other embodiments, amorphous carbon is removed simultaneously during chemical vapor deposition and also in a discrete second step.

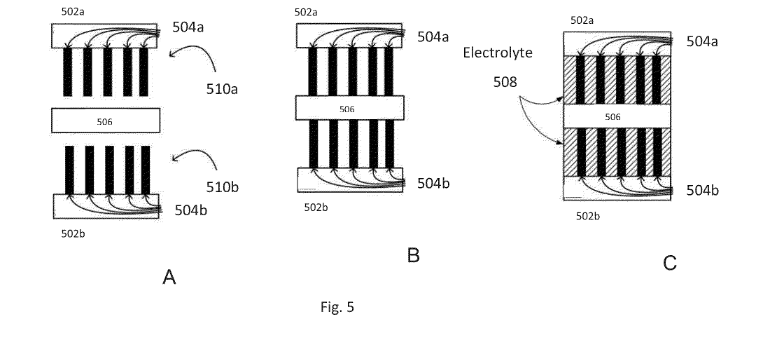

Referring now to FIG. 5A, electrodes 510a-b, which include carbon nanotubes 504a-b attached to metal foils 502a-b prepared as described, supra, and a membrane 506 is selected. Membrane 506 is a porous separator such as, for example, polypropylene, Nafion, Celgard, Celgard 3400 glass fibers or cellulose. Referring now to FIG. 5B, carbon nanotubes 504a-b attached to metal foils 502a-b are coupled to membrane 506 by a clamp assembly.

Referring now to FIG. 5C, carbon nanotubes 504a-b attached to metal foils 502a-b and coupled to membrane 506 are immersed in electrolyte 508 which may be a liquid or gel. In some embodiments, carbon nanotubes 504a-b may be suffused with a gas or combinations thereof including air. Alternatively, in some embodiments the space around carbon nanotubes 504a-b may be evacuated by a vacuum source. In some embodiments, electrolytes include, for example, aqueous electrolytes (e.g., sodium sulfate, magnesium sulfate, potassium chloride, sulfuric acid, magnesium chloride, etc.), organic solvents (e.g., acetonitrile, propylene carbonate, tetrahydrofuran, x-gamma butryolactone, etc.), ionic liquids (e.g., 1-ethyl-3-methylimidazolium bis(pentafluoroethylsulfonyl)imide, etc.), electrolyte salts soluble in organic solvents, (tetralkylammonium salts (e.g., (C₂H₅)₄NBF₄, (C₂H₅)₃CH₃NBF₄, (C₄H₉)₄NBF₄, (C₂H₅)₄NPF₆, etc.) tetralkylphosphonium salts (e.g., (C₂H₅)₄PBF₄, (C₃H₇)₄PBF₄, (C₄H₉)₄PBF₄, etc.), lithium salts (e.g., LiBF₄, LiPF₆, LiCF₃SO₃, etc., N-alkyl-pyridinium salts, 1,3 bisalkyl imidazolium salts, etc.), etc.

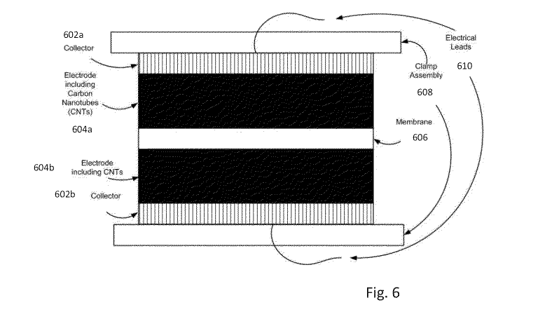

FIG. 6 is a block diagram of an exemplary ultracapacitor 600, which may be an electrochemical double layer capacitor with an operating voltage of greater than 0.05 volt. Ultracapacitor 600 has two carbon nanotube electrodes 604a-b separated by an electrolytic membrane 606. In some embodiments, carbon nanotube electrodes 604a-b may be manufactured in any continuous manufacturing process including roll to roll fashion. In some embodiments, carbon nanotube electrodes 604a-b may be made with or without removal of amorphous carbon and attached to metal foil which may include catalysts or binders or may not.

Electrical leads 610 (e.g., thin metal wires) contact collectors 602a-b (e.g., metal foils 502a-b) to make electrical contact. Ultracapacitor 600 is submerged in an electrolyte solution and leads 610 are fed out of the solution to facilitate capacitor operation. Clamp assembly 608 (e.g., coin cells or laminated cells) holds carbon nanotubes 604a-b attached to metal foil 602a-b in close proximity while membrane 606 maintain electrode separation (i.e., electrical isolation) and minimizes the volume of ultracapacitor 600.

In some embodiments, ultracapacitor 600 consists of two vertically aligned multi-walled carbon electrode tower electrodes 604a-b attached to metal foil 602a-b and an electrolytic membrane 606 (e.g., Celgard or polypropylene) which are immersed in a conventional aqueous electrolyte (e.g., 45% sulfuric acid or KOH). In other embodiments, ultracapacitor 600 consists of two vertically aligned single-walled carbon electrode tower electrodes 604a-b attached to metal foil 602a-b and an electrolytic membrane 606 (e.g., Celgard or polypropylene) which are immersed in a conventional aqueous electrolyte (e.g., 45% sulfuric acid or KOH).

In some embodiments, the ultracapacitor is a pseudo-capacitor. In some of these embodiments, carbon nanotubes are loaded with oxide particles (e.g., RuO₂, MnO₂, Fe₃O₄ etc.). In other of these embodiments, carbon nanotubes are coated with electrically conducting polymers (e.g., polypyrrole, polyaniline, polythiophene, etc.). In other embodiments the ultracapacitor is an asymmetrical capacitor (i.e., one electrode is different than the other electrode).

In some embodiments, the ultracapacitors described herein can be stacked to form multiple pairs of electrodes. In other embodiments, the ultracapacitors described herein may be used to form stacked sheets of electrodes.

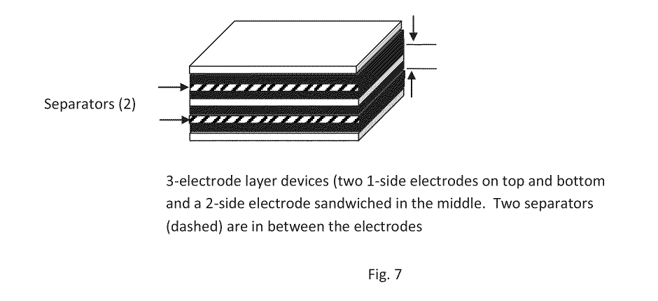

Referring now to FIG. 7, an exemplary three electrode layer device is illustrated. The device has two 1-side electrodes on the top and bottom with a two side electrode sandwiched in the middle. Two separators, as illustrated, are in between the electrodes.

The carbon nanotube electrodes described herein may be used in cellular telephone, cameras, computers, pagers, charging devices, motor vehicles, smart grids, substitutes for batteries and other storage devices, cold starting assistance, “stop and go” hybrid vehicles, catalytic converter preheating, stand-by power systems, copy machines, amplifiers, etc.

Finally, it should be noted that there are alternative ways of implementing the present invention. Accordingly, the present embodiments are to be considered as illustrative and not restrictive, and the invention is not to be limited to the details given herein, but may be modified within the scope and equivalents of the appended claims.

All publications and patents cited herein are incorporated by reference in their entirety.

What is claimed is:

1. An electrode comprising carbon nanotubes attached to a metal foil of a thickness of less than about than 500 μm.

2. The electrode of claim 1, wherein the metal foil has a root mean square roughness of less than about 200 nm.

3. The electrode of claim 1, wherein the length of the metal foil is sufficient for roll-to-roll manufacturing of the electrode.

4. The electrode of claim 1, wherein the thickness of the metal foil is between about 500 μm and about 10 μm.

5. The electrode of claim 1, wherein the thickness of the metal foil is between about 500 μm and about 1 μm.

6. The electrode of claim 1, wherein the carbon nanotubes are aligned vertically.

7. The electrode of claim 1, wherein the carbon nanotubes are aligned in a random network.

8. The electrode of claim 1, wherein the metal foil comprises a catalyst for the growth of carbon nanotubes.

9. The electrode of claim 1, wherein the metal foil comprises iron, nickel, aluminum, cobalt, copper, chromium, gold and combinations thereof.

10. The electrode of claim 1, wherein the metal foil comprises alloys of two or more of iron, nickel, cobalt, copper, chromium, aluminum, gold and combinations thereof.

11. A method of synthesizing an electrode comprising depositing carbon nanotubes on a metal foil of a thickness of less than about than 500 μm and a root mean square roughness of less than about 200 nm by chemical vapor deposition and removing amorphous carbon.

12. The method of claim 11, wherein chemical vapor deposition is a plasma enhanced or a thermal process.

13. The method of claim 11, wherein amorphous carbon is removed by water vapor treatment or chemical treatment.

14. The method of claim 11 further comprising pretreating a portion of the metal foil to inhibit synthesis of carbon nanotubes on that portion of the metal foil.

15. An ultracapacitor comprised of the electrode of claim 1.

16. The ultracapacitor of claim 15 comprised of at least two electrodes.

17. The ultracapacitor of claim 15, wherein the electrodes are current collectors.

18. The ultracapacitor of claim 15, wherein the ultracapacitor is an asymmetrical capacitor, pseudocapacitor or an electrochemical double layer capacitor.

19. The ultracapacitor of claim 16, wherein the ultracapacitor comprises multiple pairs of stacked electrodes or stacked sheets of electrodes.

20. A method of synthesizing an electrode in a roll-to-roll manufacturing process comprising depositing carbon nanotubes on a roll of metal foil and removing amorphous carbon.
